(19) United States
(12) Patent Application Publication
(10) Pub. No.: US 2017/0175557 A1
(43) Pub. Date: Jun. 22, 2017

(54) GAS TURBINE SEALING

(71) Applicant: General Electric Company, Schenectady, NY (US)

(72) Inventors: Rohit Chouhan, Bangalore (IN); Manjunath Bangalore Chengappa, Bangalore (IN); Soumyik Kumar Bhaumik, Bangalore (IN)

(73) Assignee: General Electric Company

(21) Appl. No.: 14/974,176

(22) Filed: Dec. 18, 2015

(51) Int. Cl. F01D 11/00; F01D 5/12; F04D 29/08; F04D 29/32; F04D 29/54; F01D 5/02; F01D 9/04

(52) U.S. Cl. CPC F01D 11/001; F01D 5/02; F01D 5/12; F01D 9/041; F04D 29/324; F04D 29/542; F04D 29/083; F05D 2220/32; F05D 2240/80

(57) ABSTRACT

A gas turbine having a seal sealing a trench cavity defined between a stator inboard face and rotor inboard face. The seal may include a stator overhang that extends axially toward the rotor inboard face. The stator overhang may include an overhang topside, an overhang underside, and an overhang face that is defined therebetween. The trench cavity seal may include a platform lip extending axially from the rotor inboard face toward the stator inboard face and circumferentially spaced turbulators extending axially from the rotor inboard face. An outboard edge and an inboard edge of the stator overhang axially jut such that, therebetween, a recessed pocket on the overhang face is formed. The platform lip may radially overlaps the recessed pocket on the overhang face so to form a multiple switch-back flowpath.

### BACKGROUND OF THE INVENTION

The present invention relates generally to combustion gas turbine engines (“gas turbines”), and more specifically to a rim cavity sealing systems and processes for the gas turbine engines.

During operation, because of the extreme temperatures of the hot-gas path, great care is taken to prevent components from reaching temperatures that would damage or degrade their operation or performance. One area that is particularly sensitive to extreme temperatures is the space that is inboard of the hot-gas path. This area, which is often referred to as the rim or wheelspace cavity of the turbine, contains the several turbine wheels or rotors onto which the rotating rotor blades are attached. While the rotor blades are designed to withstand the high temperatures of the hot-gas path, the rotors are not and, thus, it is necessary that the working fluid of the hot-gas path be prevented from flowing into the rim cavity. However, as will be appreciated, axial gaps necessarily exist between the rotating blades and the surrounding stationary parts, and it is through these gaps that the hot gases of the working fluid gains access to the internal regions. In addition, because of the way the engine warms up and differing thermal expansion coefficients, these gaps may widen and shrink depending on the way the engine is being operated. This variability in size makes the proper sealing of these gaps a difficult design challenge.

More specifically, gas turbines includes a turbine section with multiple rows of stator blades and rotor blades in which the stages of rotor blades rotate together around the stationary guide vanes of the stator blades. The stator blades and assemblies related thereto extend into a rim cavity formed between two stages of the rotor blades. Seals are formed between the inner shrouds of the rotor blades and the stator blades, and between the inboard surface of the stator blade diaphragm and the two rotor disk rim extensions. As will be appreciated, the hot gas flow pressure is higher on the forward side of the stator blades than on the aft side, and thus a pressure differential exists within the rim cavity. In the prior art, seals on the inboard surface of the stator diaphragm may be used to control of leakage flow across the row of stator blades. Additionally, knife edge seals may be used on the stator blade cover plate to produce a seal against the hot gas ingestion into the rim cavity. Hot gas ingestion into the rim cavity is prevented as much as possible because the rotor disks are made of relatively low temperature material than the airfoils. The high stresses operating on the rotor disks along with exposure to high temperatures will thermally weaken the rotor disk and shorten the life thereof. Purge cooling air discharge from the stator diaphragm has been used to purge the rim cavity of hot gas flow ingestion.

However, very little progress has been made in the control of rim cavity leakage flow so to reduce the usage of purge air. Difficulties regarding distribution of purge are result in inefficient usage, which, of course, comes at a cost. As will be appreciated, purging systems increase the manufacturing and maintenance cost of the engine, and are often inaccurate in terms of maintaining a desired level of pressure or outflow from the rim cavity. Further, purge flows adversely affect the performance and efficiency of the turbine engine. That is, increased levels of purge air reduce the output and efficiency of the engine. Hence, it is desirable that the usage of purge air be minimized. As a result, there is a continuing need for improved methods, systems and/or apparatus that better seal the gaps, trench cavities, and/or rim cavities from the hot gases of the flow path.

### BRIEF DESCRIPTION OF THE INVENTION

The present application thus describes a gas turbine that includes a trench cavity seal sealing the trench cavity defined between a stator inboard face of a stator blade and a rotor inboard face of a rotor blade. The trench cavity seal may include a stator overhang formed on the stator blade face that extends axially toward the rotor inboard face. The stator overhang may include an overhang topside, which defines an inner boundary of a working fluid flowpath through the turbine, an overhang underside, which opposes the overhang topside, and an overhang face, which is defined between the overhang topside and underside. The trench cavity seal may further include a platform having a platform lip extending axially from the rotor inboard face toward the stator inboard face and circumferentially spaced turbulators extending axially from the rotor inboard face, the turbulators being positioned inboard of the platform lip. An outboard edge and an inboard edge of the stator overhang may each include axially jutting edges such that, therebetween, a recessed pocket on the overhang face is formed. The platform lip may radially overlaps the recessed pocket on the overhang face of the stator overhang and be positioned relative thereto so to form a multiple switch-back flowpath in a mouth section of the trench cavity formed therebetween.

These and other features of the present application will become apparent upon review of the following detailed description of the preferred embodiments when taken in conjunction with the drawings and the appended claims.

### BRIEF DESCRIPTION OF THE DRAWINGS

These and other features of this invention will be more completely understood and appreciated by careful study of the following more detailed description of exemplary embodiments of the invention taken in conjunction with the accompanying drawings, in which:

FIG. 1 is a schematic representation of an exemplary turbine engine in which blade assemblies according to embodiments of the present application may be used;

FIG. 2 is a sectional view of the compressor section of the combustion turbine engine of FIG. 1;

FIG. 3 is a sectional view of the turbine section of the combustion turbine engine of FIG. 1;

FIG. 4 is a schematic sectional view of the inner radial portion of several rows of rotor and stator blades according to certain aspects of the present invention;

FIG. 5 is a sectional view of a trench cavity sealing arrangement assembly according to an exemplary embodiment of the present invention;

FIG. 6 is a sectional view of a trench cavity sealing arrangement assembly according to an alternative embodiment of the present invention;

FIG. 7 is a sectional view of a trench cavity sealing arrangement assembly according to an exemplary embodiment of the present invention;

FIG. 8 is a sectional view of a trench cavity sealing arrangement assembly according to an alternative embodiment of the present invention;

FIG. 9 shows an axially-facing view of a rotor inboard face of a turbine rotor blade that includes turbulators according to an embodiment of the present invention;

FIG. 10 shows schematic views of turbulators according to an alternate embodiment of the invention;

FIG. 11 shows schematic views of turbulators according to an alternate embodiment of the invention; and

FIG. 12 shows schematic views of turbulators according to an alternate embodiment of the invention.

### DETAILED DESCRIPTION OF THE INVENTION

Aspects and advantages of the invention are set forth below in the following description, or may be obvious from the description, or may be learned through practice of the invention. Reference will now be made in detail to present embodiments of the invention, one or more examples of which are illustrated in the accompanying drawings. The detailed description uses numerical designations to refer to features in the drawings. Like or similar designations in the drawings and description may be used to refer to like or similar parts of embodiments of the invention. As will be appreciated, each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents. It is to be understood that the ranges and limits mentioned herein include all sub-ranges located within the prescribed limits, inclusive of the limits themselves unless otherwise stated. Additionally, certain terms have been selected to describe the present invention and its component subsystems and parts. To the extent possible, these terms have been chosen based on the terminology common to the technology field. Still, it will be appreciate that such terms often are subject to differing interpretations. For example, what may be referred to herein as a single component, may be referenced elsewhere as consisting of multiple components, or, what may be referenced herein as including multiple components, may be referred to elsewhere as being a single component. In understanding the scope of the present invention, attention should not only be paid to the particular terminology used, but also to the accompanying description and context, as well as the structure, configuration, function, and/or usage of the component being referenced and described, including the manner in which the term relates to the several figures, as well as, of course, the precise usage of the terminology in the appended claims. Further, while the following examples are presented in relation to a certain type of gas turbine or turbine engine, the technology of the present invention also may be applicable to other types of turbine engines as would the understood by a person of ordinary skill in the relevant technological arts.

Given the nature of gas turbine operation, several descriptive terms may be used throughout this application so to explain the functioning of the engine and/or the several sub-systems or components included therewithin, and it may prove beneficial to define these terms at the onset of this section. Accordingly, these terms and their definitions, unless stated otherwise, are as follows. The terms “forward” and “aft” or “aftward”, without further specificity, refer to directions relative to the orientation of the gas turbine. That is, “forward” refers to the forward or compressor end of the engine, and “aft” or “aftward” refers to the aft or turbine end of the engine. It will be appreciated that each of these terms may be used to indicate movement or relative position within the engine. The terms “downstream” and “upstream” are used to indicate position within a specified conduit relative to the general direction of flow moving through it. (It will be appreciated that these terms reference a direction relative to an expected flow during normal operation, which should be plainly apparent to anyone of ordinary skill in the art.) The term “downstream” refers to the direction in which the fluid is flowing through the specified conduit, while “upstream” refers to the direction opposite that. Thus, for example, the primary flow of working fluid through a gas turbine, which begins as air moving through the compressor and then becomes combustion gases within the combustor and beyond, may be described as beginning at an upstream location toward an upstream or forward end of the compressor and terminating at a downstream location toward a downstream or aft end of the turbine. In regard to describing the direction of flow within a common type of combustor, as discussed in more detail below, it will be appreciated that compressor discharge air typically enters the combustor through impingement ports that are concentrated toward the aft end of the combustor (relative to the combustors longitudinal axis and the aforementioned compressor/turbine positioning defining forward/aft distinctions). Once in the combustor, the compressed air is guided by a flow annulus formed about an interior chamber toward the forward end of the combustor, where the air flow enters the interior chamber and, reversing it direction of flow, travels toward the aft end of the combustor. In yet another context, the flow of coolant through cooling channels or passages may be treated in the same manner.

Additionally, the term “rotor blade”, without further specificity, is a reference to the rotating blades of either the compressor or the turbine, which include both compressor rotor blades and turbine rotor blades. The term “stator blade”, without further specificity, is a reference to the stationary blades of either the compressor or the turbine, which include both compressor stator blades and turbine stator blades. The term “blades” will be used herein to refer to either type of blade. Thus, without further specificity, the term “blades” is inclusive to all type of turbine engine blades, including compressor rotor blades, compressor stator blades, turbine rotor blades, and turbine stator blades.

Finally, given the configuration of compressor and turbine about a central common axis, as well as the cylindrical configuration common to many combustor types, terms describing position relative to an axis may be used herein. In this regard, it will be appreciated that the term “radial” refers to movement or position perpendicular to an axis. Related to this, it may be required to describe relative distance from the central axis. In this case, for example, if a first component resides closer to the central axis than a second component, the first component will be described as being either “radially inward” or “inboard” of the second component. If, on the other hand, the first component resides further from the central axis than the second component, the first component will be described herein as being either “radially outward” or “outboard” of the second component. Additionally, as will be appreciated, the term “axial” refers to movement or position parallel to an axis. Finally, the term “circumferential” refers to movement or position around an axis. As mentioned, while these terms may be applied in relation to the common central axis that extends through the compressor and turbine sections of the engine, these terms also may be used in relation to other components or sub-systems of the engine.

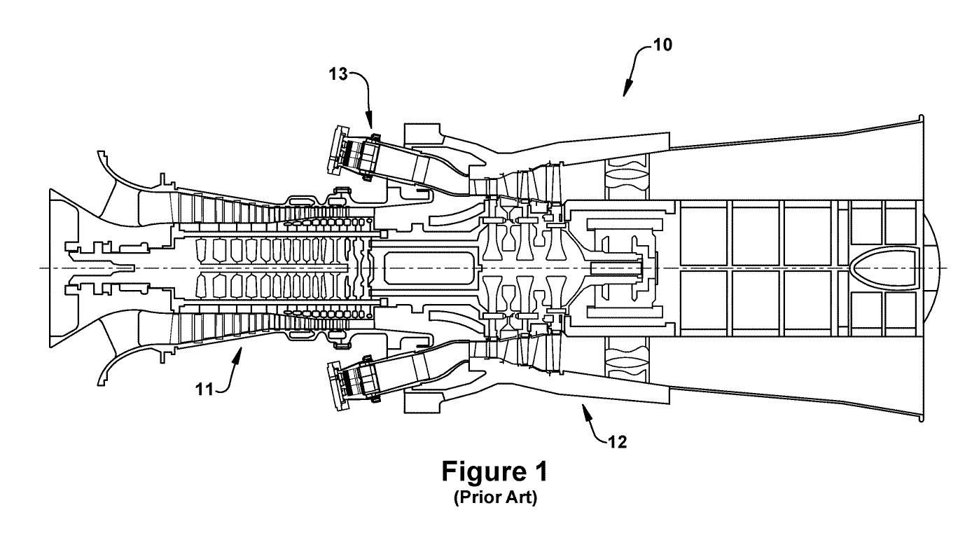

By way of background, referring now to the figures, FIGS. 1 through 3 illustrate an exemplary gas turbine in which embodiments of the present application may be used. It will be understood by those skilled in the art that the present invention is not limited to this type of usage. As stated, the present invention may be used in gas turbines, such as the engines used in power generation and airplanes, steam turbine engines, and other types of rotary engines. The examples provided are not meant to be limiting to the type of the turbine engine. FIG. 1 is a schematic representation of a gas turbine 10. In general, gas turbines operate by extracting energy from a pressurized flow of hot gas produced by the combustion of a fuel in a stream of compressed air. As illustrated in FIG. 1, gas turbine 10 may be configured with an axial compressor 11 that is mechanically coupled by a common shaft or rotor to a downstream turbine section or turbine 12, and a combustor 13 positioned between the compressor 11 and the turbine 12. As illustrated in FIG. 1, the gas turbine may be formed about a common central axis 19.

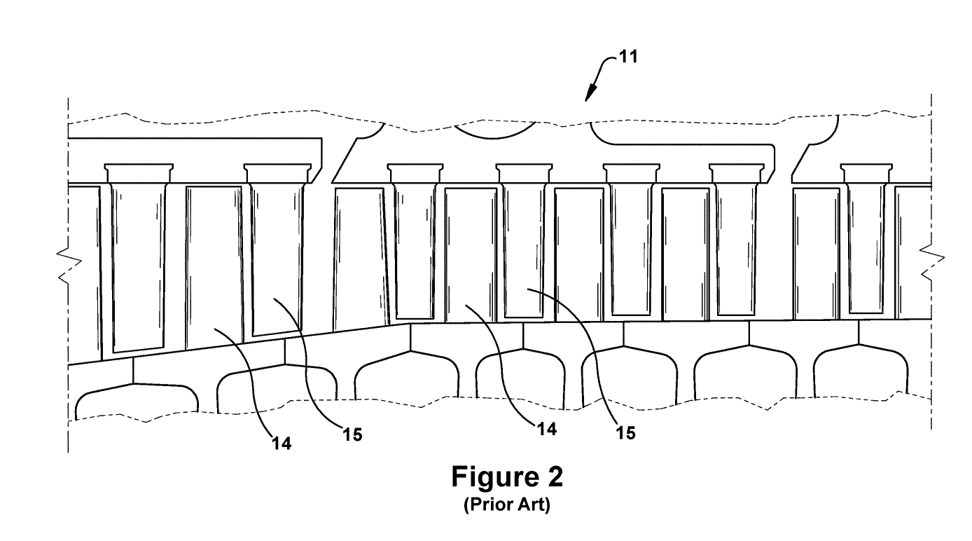

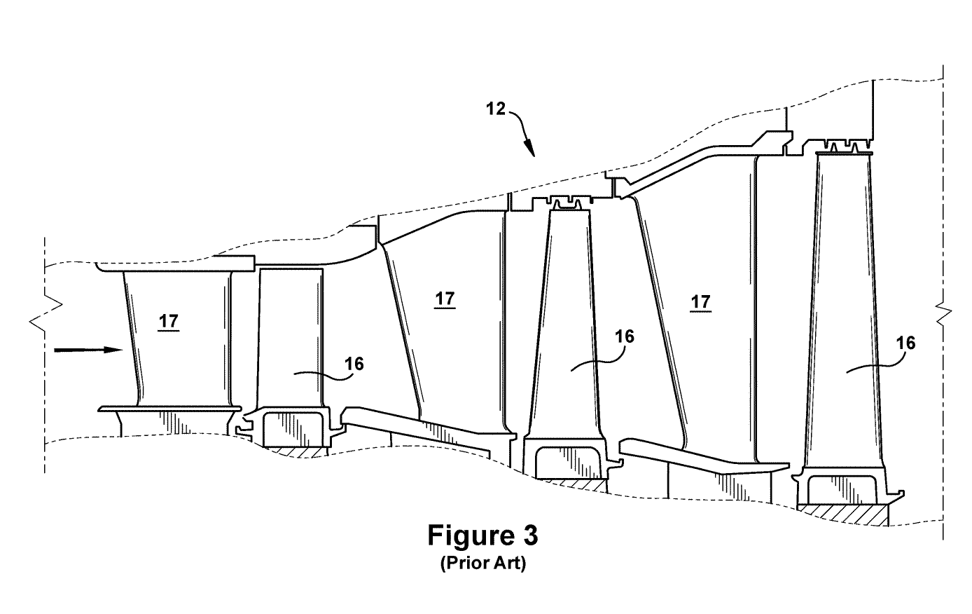

FIG. 2 illustrates a view of an exemplary multi-staged axial compressor 11 that may be used in the gas turbine of FIG. 1. As shown, the compressor 11 may have a plurality of stages, each of which include a row of compressor rotor blades 14 and a row of compressor stator blades 15. Thus, a first stage may include a row of compressor rotor blades 14, which rotate about a central shaft, followed by a row of compressor stator blades 15, which remain stationary during operation. FIG. 3 illustrates a partial view of an exemplary turbine section or turbine 12 that may be used in the gas turbine of FIG. 1. The turbine 12 also may include a plurality of stages. Three exemplary stages are illustrated, but more or less may be present. Each stage may include a plurality of turbine nozzles or stator blades 17, which remain stationary during operation, followed by a plurality of turbine buckets or rotor blades 16, which rotate about the shaft during operation. The turbine stator blades 17 generally are circumferentially spaced one from the other and fixed about the axis of rotation to an outer casing. The turbine rotor blades 16 may be mounted on a turbine wheel or rotor disc (not shown) for rotation about the shaft (not shown). It will be appreciated that the turbine stator blades 17 and turbine rotor blades 16 lie in the hot gas path or working fluid flowpath through the turbine 12. The direction of flow of the combustion gases or working fluid within the working fluid flowpath is indicated by the arrow.

In one example of operation, the rotation of compressor rotor blades 14 within the axial compressor 11 may compress a flow of air. In the combustor 13, energy may be released when the compressed air is mixed with a fuel and ignited. The resulting flow of hot gases or working fluid from the combustor 13 is then directed over the turbine rotor blades 16, which induces the rotation of the turbine rotor blades 16 about the shaft. In this way, the energy of the flow of working fluid is transformed into the mechanical energy of the rotating blades and, given the connection between the rotor blades and the shaft, the rotating shaft. The mechanical energy of the shaft may then be used to drive the rotation of the compressor rotor blades 14, such that the necessary supply of compressed air is produced, and also, for example, a generator to produce electricity.

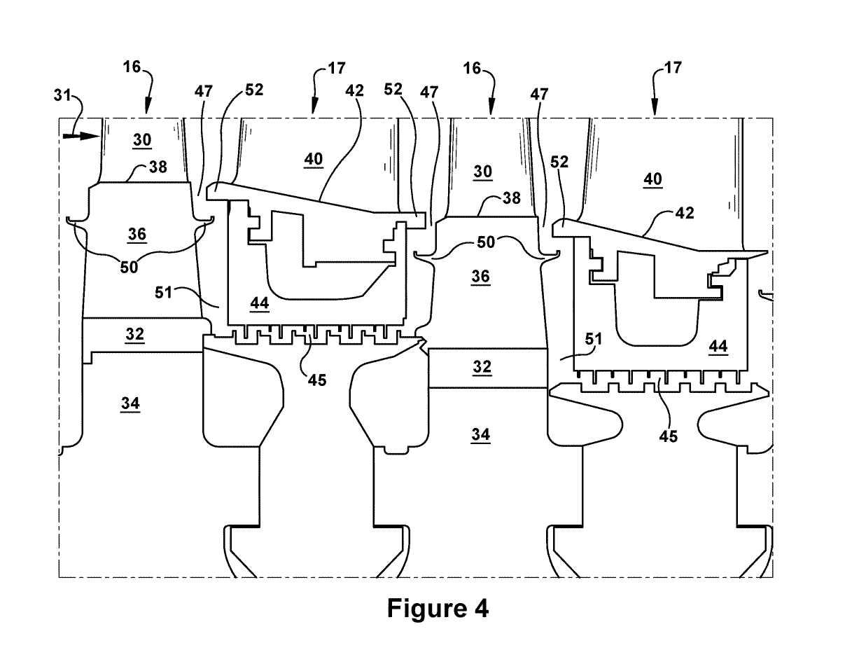

FIG. 4 schematically illustrates a sectional view of the several rows of blades as they might be configured in a turbine 12 of a gas turbine 10 according to certain aspects of the present application. As one of skill in the art will appreciate, the view includes the inboard structure of two rows of rotor blades 16 and stator blades 17. Each rotor blade 16 generally includes an airfoil 30 that resides in the hot-gas path and interacts with the working fluid of the turbine 12 (the flow direction of which is indicated by arrow 31). The rotor blade 16 may further include a root 32, which is used to attach the rotor blade 16 to a rotor wheel 34. For example, the root 32 may be configured as a dovetail that engages a corresponding dovetail slot formed in the rotor wheel 34. The rotor blade 16 may further include a shank 36, which is the radial portion residing between the root 32 and the airfoil 30. The shank 36 may include a platform 38 from which the airfoil 30 extends. Each stator blade 17 generally includes an airfoil 40 that resides in the hot-gas path and interacts with the flow of working fluid through the turbine 12, and, radially inward of the airfoil 40, an assembly including an inner sidewall 42 and a diaphragm 44. Typically, the inner sidewall 42 is integral to the airfoil 40 and forms the inner boundary of the working fluid flowpath through the turbine 12. The diaphragm 44 typically attaches to the inner sidewall 42 (though may be formed integral therewith) and extends in an inward radial direction to form a seal 45 with rotating components positioned just inboard of it.

As further illustrated in FIG. 4, axial gaps may be present between rotating and stationary components along the radially inward edge or inner boundary of the working fluid flowpath within the turbine 12. These gaps, which will be referred to herein as trench cavities 47, are present because of the space that is typically maintained between the rotating parts (i.e., the rotor blades 16) and the stationary parts (i.e., the stator blades 17). Because of the way the engine warms up and operates at different load levels, the width of the trench cavity 47 (i.e., the axial distance across the gap) may vary significantly. This, for example, may be caused by differing thermal expansion coefficients between the components. The trench cavity 47, thus, may widen and shrink depending on the way the gas turbine is being operated. Because it is highly undesirable for the rotating parts to rub against stationary parts, gas turbines are typically designed such that at least some space is maintained at the trench cavity 47 locations during all operating conditions, which results in a trench cavity 47 having a narrow opening during some operating conditions and a relatively wide opening during others. Of course, a relatively wide trench cavity is undesirable because it invites working fluid into the inner spaces of the turbine 12, which may damage the rotor wheels 34 and other more sensitive components that reside within this region.

It will be appreciated that a trench cavity 47 may be present at each point along the radially inward or inner boundary of the working fluid flowpath where rotating parts border stationary parts. Thus, as illustrated, a trench cavity 47 may be formed between the trailing edge of the rotor blade 16 and the leading edge of the stator blade 17, and between the trailing edge of the stator blade 17 and the leading edge of the rotor blade 16. Typically, in regard to the rotor blade 16, the shank 36 defines one edge of the trench cavity 47, and, in regard to the stator blades 17, the inner sidewall 42 defines the opposing edge of the trench cavity 47. Axial projections 50, which will be discussed in more detail below, may be configured within the trench cavity 47 so to provide a tortuous path or seal that limits ingestion of working fluid. Axial projections 50 may be defined as radially thin extensions that protrude axially from either the inboard structure or faces of the rotor blades 16 or the stator blades 17. The axial projection 50, as will be appreciated, may be included on each of the circumferentially spaced blades 16, 17 within a particular row such that, together, the axial projections 50 extend circumferentially about the central axis of the turbine 12. As shown, according to certain embodiments, the axial projection 50 may be included on the rotor blade 16 and configured as a so called “angel wing” projection that extends from the inboard structure of the rotor blade 16. As illustrated, inboard of the angel wing axial projection 50, the trench cavity 47 may be described as transitioning into a wheelspace cavity 51. Outboard of the angel wing axial projection 50, as indicated, the stator blade 17 may be configured to include an inner sidewall 42 that projects toward the rotor blade 16 such that a stator overhang 52 is formed. As used herein, the stator overhang 52 is a feature that extends from the stator blade 17 and overhangs or is cantilevered over a portion of the trench cavity 47.

As stated, it is desirable to prevent the working fluid of the working fluid flowpath from entering the trench cavity 47 and the wheelspace cavity 51 because the extreme temperatures of the hot gases may damage the components within this area. According to aspects of the present invention, the axial projection 50 and the stator overhang 52, as illustrated, may be configured so to axially overlap, which may limit some of this ingestion. However, because of the varying width of the trench cavity 47 and the limitations of such seals, the trench cavity 47 may still require purging with compressed air bled from the compressor so to insure against working fluid ingestion. As stated, because purge air negatively affects the performance and efficiency of the gas engine, its usage should be minimized.

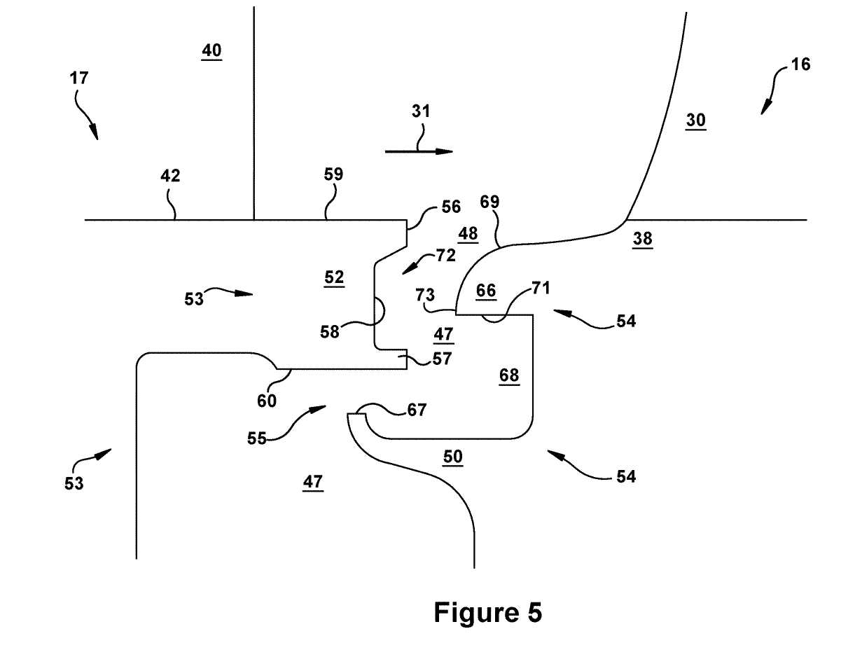

FIGS. 5 through 8 provide sectional views of a trench cavity seal according to embodiments of the present invention. As will be appreciated, the described embodiments include specific geometrical arrangements of several sealing component types that achieve a cost-effective and efficient sealing solution. As applicants have discovered, these components, as arranged in the manner described and claimed in the appended claim set, may act together to create beneficial flow patterns that provide significant sealing benefits without the overreliance on purge air, which may enhance overall engine efficiency. Further, the arrangements described herein accomplished sealing objectives without the restrictive interlocking and complex configurations that often increase maintenance costs and machine downtime. More specifically, the axial overlap between the stator blade assemblies and the rotor blade assemblies across the trench cavity is configured so to allow inboard drop-in installation of the stator blade assemblies relative to an already installed row or rows of neighboring rotor blades. The trench cavity seal, according to preferred embodiments, may include outboard sealing structure positioned on the stator blade assemblies that axially overlaps inboard sealing structure positioned on the rotor blade assemblies, but, as will be appreciated upon inspection of FIGS. 5 through 8, these structures do not interlock therewith so to hinder or prevent the drop-in installation of the stator blades.

As illustrated in FIG. 5, the trench cavity seal 55 may include components that axially extend from opposing inboard structure related to the stator blade 17 and the rotor blade 16. As used herein, this inboard structure will generally be referred to as a stator inboard face 53 and rotor inboard face 54. These terms are intended to refer to the structure of the stator blade 17 and the rotor blade 16, respectively, that is positioned inboard of the main working fluid pathway through the turbine 12. Another way to describe the stator inboard face 53 and the rotor inboard face 54 is that each includes the structure that is positioned inboard of the stator blade airfoil 40 and the rotor blade airfoil 30, respectively. As will be appreciated, the stator inboard face 53 and the rotor inboard face 54 oppose each other across the trench cavity 47.

As shown, the stator inboard face 53 may include a stator overhang 52 that axially projects toward the rotor inboard face 54. As will be appreciated, the stator overhang 52 may include an overhanging portion of the sidewall 42. As such, the stator overhang 52 may define an axial section of the inner boundary of working fluid flowpath. The outboard surface of the stator overhang 52, as used herein, will be referred to as an overhang topside 59. As indicated, the stator overhang 52 also may include an overhang underside 60 that opposes the overhang topside 59 across the body of the stator overhang 52. An overhang face 58, as used herein, refers to the radially oriented face that connects the overhang topside 59 to the overhang underside 60. The overhang face 58 defines a boundary of the trench cavity 47 and may be oriented so to face the rotor inboard face 54. As illustrated, edges are defined in profile between the overhang topside 59 and the overhang face 58 as well as between the overhang underside 60 and the overhang face 58. The edge defined between the overhang topside 59 and the overhang face 58, as used herein, will be referred to herein as an outboard edge 56, while the edge defined between the overhang underside 60 and the overhang face 58 will be referred to herein as an inboard edge 57. Thus, the stator overhang 52 may be described as including the outboard edge 56 and inboard edge 57 and, defined between those two features, the overhang face 58.

The rotor inboard face 54, as illustrated, may include a platform lip 66 portion of the platform 38 that extends or juts axially toward the stator inboard face 53. As will be appreciated, the platform 38 of the rotor blade 16 defines an axial section of the inner boundary of the working fluid flowpath. The platform lip 66, thus, may generally oppose the stator overhang 52 across an outboard region or mouth section (or “mouth 48”) of the trench cavity 47. The platform lip 66 generally is formed by an axially jutting, cantilevered portion of the platform 38. As indicated, the platform lip 66 may be described as having a topside 69 and underside 71. According to certain configurations, the platform topside 69 may curve smoothly inboard such that the platform lip 66 tapers in radial width as it nears the stator inboard face 53. As indicated, the tapering platform lip 66 may taper to a tip 73, which represents the furthest point of extension for the platform lip 66.

The rotor inboard face 54 may further include an axial projection 50 that resides inboard of the platform lip 66. The axial projection 50 may be a radially thin feature that extends axially toward the stator inboard face 53, and, as discussed more below, may include an upturned tip or “angel wing” configuration. The rotor inboard face 54 may further include a pocket 68. The pocket 68, as indicated, is the region overhung by the platform lip 66. The pocket 68 may be radially defined between the underside 60 of the platform lip 66 and the axial projection 50.

According to certain embodiments of the trench cavity seal 55, the inboard edge 57 of the stator overhang 52, as illustrated, may be configured to have an axially jutting configuration. As shown, the inboard edge 57 having the axially jutting configuration may be configured so to radially overlap with the radial height of the pocket 68, which, as stated, is defined between the underside 71 of the platform lip 66 and the axil projection 50. According to other embodiments, the inboard edge 57 having the axially jutting configuration may be made to radially coincide with the approximate radial midpoint of the radial height of the pocket 68.

According to other embodiments of the trench cavity seal 55, the outboard edge 56 of the stator overhang 52 also may be configured to have an axially jutting configuration. As indicated, when both the outboard edge 56 and inboard edge 57 of the stator overhang 52 have axially jutting configurations, a recessed pocket 72 is formed on the overhang face 58. According to certain embodiments, the trench cavity seal 55 includes the outboard boundary of the pocket 68 being positioned so to radially overlap the recessed pocket 72 formed on the overhang face 58. According to other embodiments, the outboard boundary of the pocket 68 may be positioned so to radially coincide with the approximate radial midpoint of the recessed pocket 72 formed on the overhang face 58. According to other exemplary embodiments, the tip 73 of the platform lip 66 is radially aligned within the radial height of the recessed pocket 72, which is a range defined between the inboard and outboard edges 56, 57 of the stator overhang 52. According to certain embodiments, the platform lip 66 is wholly contained within the radial height of the recessed pocket 72.

According to alternative embodiments of the present invention, the axial projection 50 is positioned inboard relative to the stator overhang 52 and is configured to axially overlap therewith. As illustrated, the stator overhang 52 and the axial projection 50 may be configured such that the stator overhang 52 axially overlaps a significant portion of the axial projection 50. The stator overhang 52, thus, overhangs at least a tip 67 of the axial projection 50. As stated, the axial projection 50 may have an angel wing configuration. As illustrated, this type of configuration may include an upturned, concave lip at the tip 67.

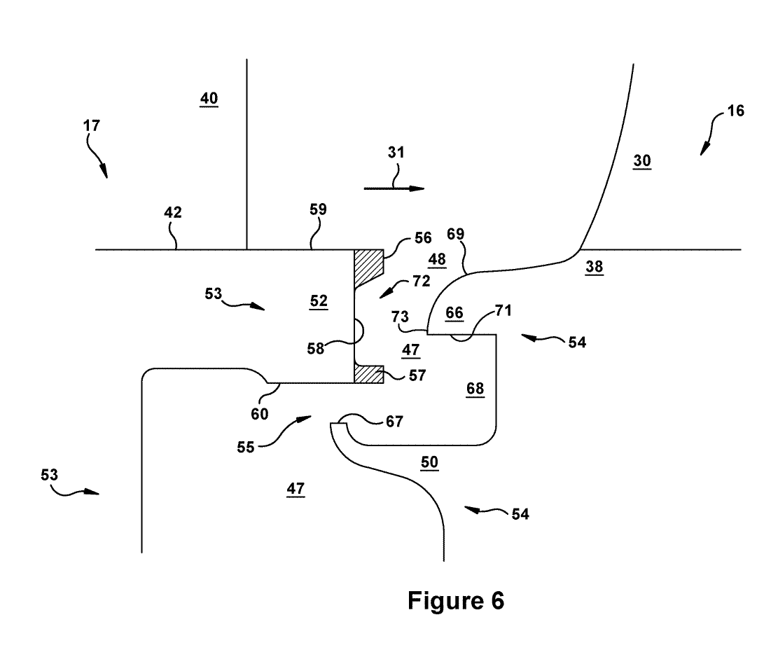

FIG. 6 illustrates an alternative embodiment wherein the axially jutting edges of the outboard edge 56 and inboard edge 57 of the stator overhang 52 (as depicted by the shaded region) are constructed with components that are non-integral relative to the stator overhang 52. According to certain preferred embodiment, the jutting outboard and inboard edges 56, 57 may be formed using an abradable coating. For example, according to certain embodiments, the abradable coating may include SF aluminum, nickel-graphite, or aluminum oxide base ceramic. Other materials are also possible.

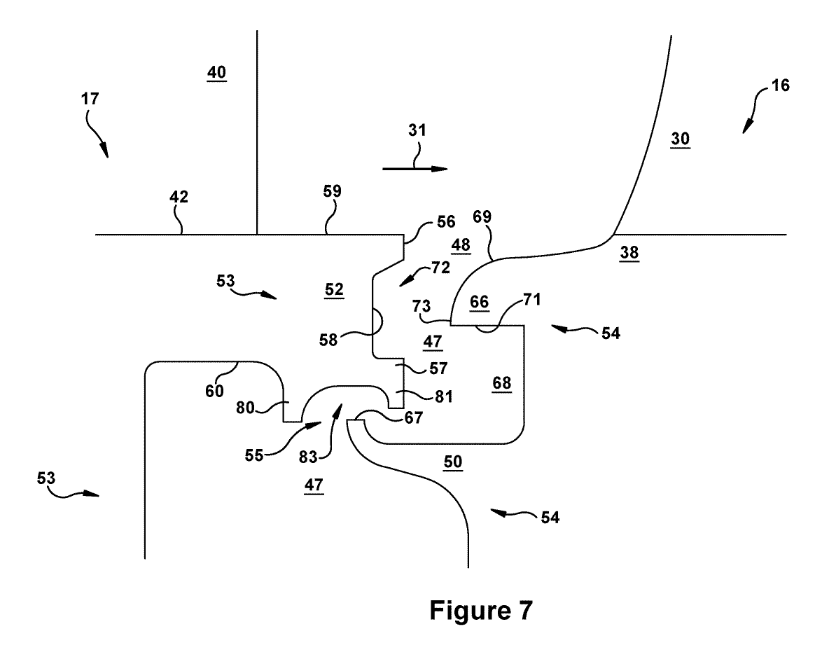

As illustrated in FIG. 7, the trench cavity seal 55 of the present invention may further include a seal formed on the underside 60 of the stator overhang 52. As shown, according to an exemplary embodiment, this seal may be formed via inboard jutting protuberances, an inner protuberance 80 (which is positioned nearer the stator inboard face 53) and an outer protuberance 81 (which is positioned nearer the rotor inboard face 54). Preferably, these inboard jutting protuberances 80, 81 may be positioned to cooperate with an upturned tip 67 of the axial projection 50 of the inboard rotor face 54. As will be appreciated, the inner protuberance 80 and the outer protuberance 81, as illustrated, may be configured to define an underside recessed pocket 83. According to exemplary embodiments of the trench cavity seal 55, the inner protuberance 80 and the outer protuberance 81 may be configured such that the underside recessed pocket 83 axially corresponds with the tip 67 of an axial projection 50.

As described, the axial projection 50 is a feature that may be positioned inboard relative to the stator overhang 52 and, extending from the rotor inboard face 54 toward the stator inboard face 53, may be configured such that the tip 67 of the axial projection 50 axially overlaps the stator overhang 52. As depicted, according to exemplary embodiments, the axial projection 50 may be configured to have an upturned tip 67. For example, this upturned tip 67 may be part of the already described “angel wing” configuration in which a concave lip curls in the outboard direction. Specifically, the upturned tip 67 may curl or extend toward the overhang underside 60 of the stator overhang 52. As illustrated, according to preferred embodiments, this upturned tip 67 of the axial projection 50 may be configured so to axially coincide with a range defined between the inboard jutting inner and outer protuberances 80, 81. As such, the upturned tip 67 may axial coincide with the axial width of the underside recessed pocket 83 as defined between the protuberances 80, 81. According to certain preferred embodiments, the upturned tip 67 of the axial projection 50 is configured so to axially coincide with the approximate axial midpoint of the underside recessed pocket 83. In this manner, the trench cavity seal 55 of the present invention may include further corresponding structures that cooperate in order to induce a flowpath through the trench cavity 47 having multiple switch-backs that limits hot gas ingestion.

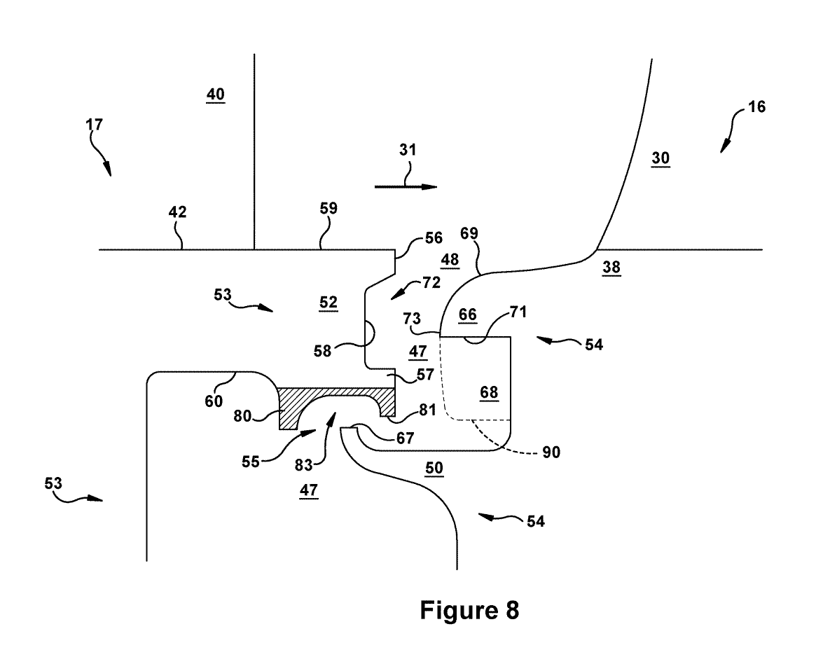

FIG. 8 illustrates an alternative embodiment wherein the inboard jutting inner and outer protuberances 80, 81 (as depicted by the shaded region) are constructed with non-integral components relative to the stator overhang 52. According to preferred embodiments, the inner protuberance 80 and the outer protuberance 81 may be constructed using an abradable coating. For example, according to certain embodiments, the abradable coating may include SF aluminum, nickel-graphite, or aluminum oxide base ceramic. Other materials are also possible.

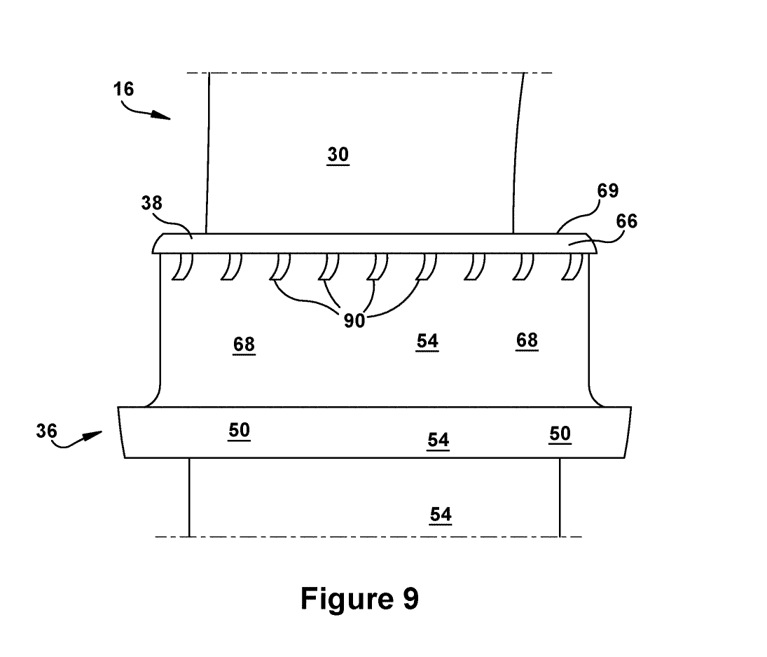

In this manner, as will be appreciated, the several components of the trench cavity seal 55, as provided above with reference to FIGS. 5 though 8, may cooperate so to induce a tortuous flowpath in the trench cavity 47. This flowpath, as discussed, may include multiple switch-backs that limit ingestion of hot gases from the working fluid flowpath. As also indicated in FIG. 8, the trench cavity seal 55 of the present invention may include turbulators 90 formed just inboard of or near the platform lip 66, such as within the region previously identified as the pocket 68. As will be appreciated, such turbulators 90, which are discussed in more detail below with reference to FIGS. 9 through 12, may be combined without limitation to any of the above-present features.

FIG. 9 shows a schematic view of a rotor blade 16 looking axially toward the rotor inboard face 54. As can be seen, the rotor blade 16 includes a plurality of the turbulators 90, each of which may extend axially outward from rotor inboard face 54 and/or radially inward from the underside 71 of the platform lip 66. As will also be described in greater detail below, the turbulators 90 may be of any number of shapes and orientations.

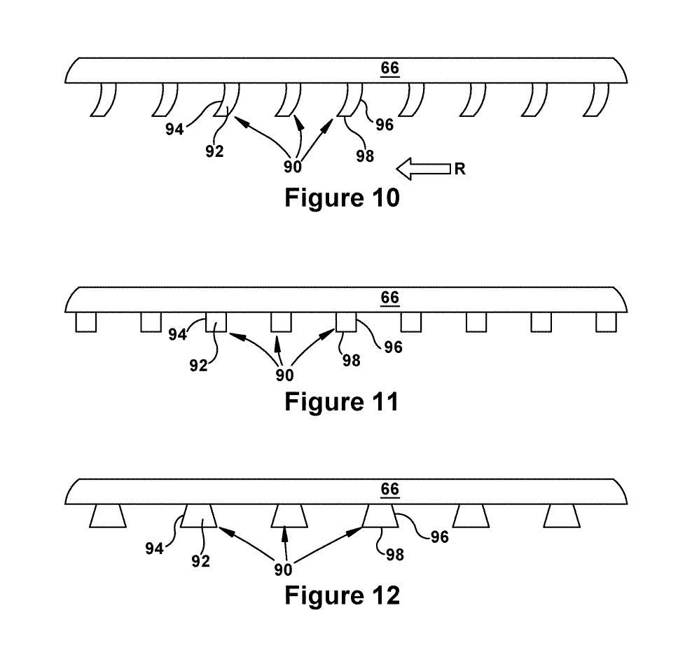

For example, FIG. 10 shows a detailed view of a rotor inboard face 54 having turbulators 90. As shown, each of the turbulators 90 forms a rib-like member or body 92 extending radially inward from underside 71 of the platform lip 66. The turbulator 90 may include a first concave face 94 opening toward an intended direction of rotation R of the rotor blade 16, a second convex face 96 opposite first concave face 94, and a radially inner face 98 between first and second concave faces 94, 96. As will be appreciated, these faces 92, 94, 98 define a body 92 of each turbulator 90. In other embodiments of the invention, the turbulators 90 may be separated from underside 71 of the platform lip 66 and extend axially from rotor inboard face 54 within the pocket 68. In either case, one or more of the turbulators 90 may be axially angled, such that, for example, the first concave face 94 extends from the rotor inboard face 54, as illustrated, at an angle, positive or negative, relative to a longitudinal axis of the turbine 12. Embodiments of the invention employing axially angled turbulators 90 typically include one or more turbulators which, when installed, may be angled ±70 degrees relative to the longitudinal axis of the turbine.

As will be appreciated, in operation, the turbulators 90 may draw in purge air and increase its swirl velocity. While this may result in a small loss of torque, a net gain in efficiency of approximately 0.5% at the turbine stage may be achieved. This gain is a consequence of both the increased purge air swirl velocity, which produces a curtaining effect, described further below, as well as a change in swirl angle of the purge air. This change in swirl angle results in the purge air being better aligned with the hot gas flow, resulting in significantly reduced mixing losses when purge air escapes from trench cavity to join the flow of working fluid.

FIGS. 11 and 12 show turbulators 90 having different configurations. In FIG. 10, the first and second faces 94, 96 are substantially straight and the radially inner face 98 is substantially perpendicular to both first and second faces 94, 96, such that the body 92 is substantially rectangular in cross-section. In FIG. 12, each of the first and second faces 94, 96 are substantially straight but radially non-perpendicularly angled, such that the body 92 has a substantially trapezoidal cross-sectional shape, with the wider dimension disposed radially inward. Other configurations are also possible, as shown in copending and commonly assigned U.S. patent application Ser. No. 14/603,314, which is hereby incorporated herein in its entirety, without limitation. As described therein, the first and second faces of the turbulator may be radially non-perpendicularly angled such that the body of the turbulator has a substantially trapezoidal cross-sectional shape, with the narrower dimension disposed radially inward. Additionally, each turbulator may be formed by the intersection of a radially inner surface and at least one adjacent arcuate face may be disposed on either side of radially inner surface. End faces may be substantially straight and extend radially from platform, thereby enclosing the plurality of the turbulators. The turbulators, according to other embodiments of the invention, may extend axially outward from the rotor inboard face and/or radially inward from a radially inner surface of platform.

As one of ordinary skill in the art will appreciate, the many varying features and configurations described above in relation to the several exemplary embodiments may be further selectively applied to form the other possible embodiments of the present invention. For the sake of brevity and taking into account the abilities of one of ordinary skill in the art, each possible iteration is not herein discussed in detail, though all combinations and possible embodiments embraced by the several claims below are intended to be part of the instant application. In addition, from the above description of several exemplary embodiments of the invention, those skilled in the art will perceive improvements, changes and modifications. Such improvements, changes and modifications within the skill of the art are also intended to be covered by the appended claims. Further, it should be apparent that the foregoing relates only to the described embodiments of the present application and that numerous changes and modifications may be made herein without departing from the spirit and scope of the application as defined by the following claims and the equivalents thereof.

That which is claimed:

1. A gas turbine engine comprising a turbine including a stator blade and a rotor blade having a seal formed in a trench cavity formed therebetween, the trench cavity comprising an axial gap defined between a stator inboard face and a rotor inboard face, the seal comprising:
a stator overhang formed on the stator blade face that extends axially toward the rotor inboard face, the stator overhang comprising an overhang topside, which defines an inner boundary of a working fluid flowpath through the turbine, an overhang underside, which opposes the overhang topside, and an overhang face, which is defined between the overhang topside and underside;
a platform having a platform lip extending axially from the rotor inboard face toward the stator inboard face; and
circumferentially spaced turbulators extending axially from the rotor inboard face, the turbulators being positioned inboard of the platform lip;
wherein an outboard edge and an inboard edge of the stator overhang each comprises an axially jutting edge such that, therebetween, a recessed pocket on the overhang face is formed; and
wherein the platform lip radially overlaps the recessed pocket on the overhang face of the stator overhang and is positioned relative thereto so to form a first multiple switch-back flowpath in a mouth section of the trench cavity formed therebetween.

2. The gas turbine according to claim 1, wherein the overhang topside and the overhang underside are approximately axially oriented, and the overhang face is approximately radially oriented;
wherein the rotor inboard face comprises structure of the rotor blade that is inboard of an airfoil of the rotor blade, and the stator inboard face comprises structure of the stator blade that is inboard of an airfoil of the stator blade;
wherein the outboard edge comprises an edge defined between the overhang topside and the overhang face, and the inboard edge comprises an edge defined between the overhang underside and the overhang face; and
wherein the turbulators, in an operative state, comprise a configuration adapted to change a swirl velocity of purge air within the trench cavity.

3. The gas turbine according to claim 2, further comprising an axial projection extending from the rotor inboard face toward the stator inboard face;
wherein the axial projection of the rotor inboard face is positioned inboard relative the stator overhang and overhung at least partially thereby; and
wherein the turbulators comprise a position on the rotor inboard face between the platform lip and the axial projection.

4. The gas turbine according to claim 3, wherein the platform comprises a topside that bounds the working fluid flowpath and an opposing the rotor inboard face defines a pocket that is overhung by the platform lip, the pocket being radially defined by an underside of the platform lip and the axial projection; and
wherein the turbulators are formed within the pocket.

5. The gas turbine according to claim 4, wherein the platform lip comprises a topside that defines a section of the inner boundary of the working fluid flowpath; and
wherein the topside of the platform lip comprises an inboard curvature as the platform lip extends toward the stator inboard face so that the platform lip tapers to a tip.

6. The gas turbine according to claim 5, wherein the inboard edge of the stator overhang radially overlaps the pocket of the rotor inboard face.

7. The gas turbine according to claim 6, wherein the inboard edge of the stator overhang approximately radially coincides with a radial midpoint of the pocket of the rotor inboard face.

8. The gas turbine according to claim 6, wherein the platform lip of the rotor inboard face radially overlaps the recessed pocket formed on the overhang face of the stator overhang.

9. The gas turbine according to claim 8, wherein the platform lip of the rotor inboard face is wholly contained within a radial range defined by the recessed pocket of the overhang face of the stator overhang.

10. The gas turbine according to claim 6, wherein the jutting edges of the outboard edge and an inboard edge of the stator overhang comprise a non-integral material relative to the stator overhang; and
wherein the turbulators are radially offset in an inboard direction from the underside of the platform lip.

11. The gas turbine according to claim 10, wherein the non-integral material comprises an abradable coating.

12. The gas turbine according to claim 6, wherein the stator overhang further comprises inner and outer protuberances that jut radially inboard and, between the inner and outer protuberances, an underside recessed pocket;
wherein the axial projection comprises a tip that is overhung by the stator overhang so that the tip of the axial projection axially aligns with the underside recessed pocket; and
wherein each of the turbulators comprises a rib-like member extending radially inward.

13. The gas turbine according to claim 12, wherein the tip of the axial projection comprises an upturned tip that extends toward an outboard direction such that a second multiple switch-back flowpath is formed between the tip of the axial projection and the underside recessed pocket; and
wherein the rib-like members of the turbulators comprise a concave face opening toward an intended direction of rotation of the rotor blade.

14. The gas turbine according to claim 12, wherein the tip of the axial projection comprises an upturned tip that extends toward an outboard direction such that a second multiple switch-back flowpath is formed with between the tip of the axial projection and the underside recessed pocket; and
wherein the rib-like members of the turbulators are axially angled away from an intended direction of rotation of the rotor blade.

15. The gas turbine according to claim 12, wherein the tip of the axial projection comprises an upturned tip that extends toward an outboard direction such that a second multiple switch-back flowpath is formed with between the tip of the axial projection and the underside recessed pocket; and
wherein the rib-like members of the turbulators are axially angled toward an intended direction of rotation of the rotor blade.

16. The gas turbine according to claim 12, wherein the axial projection comprises an angel wing configuration in which the upturned tip comprises a concave lip that curls in an outboard direction and toward the overhang underside of the stator overhang;
wherein the upturned tip of the axial projection approximately axially coincides an axial midpoint of the underside recessed pocket; and
wherein each of the turbulators is affixed along the underside of the platform lip.

17. The gas turbine according to claim 16, wherein the inner and outer protuberances that form the underside recessed pocket comprise a non-integral material relative to the stator overhang, and wherein the non-integral material comprises an abradable coating.

18. The gas turbine according to claim 2, wherein:
the trench cavity comprises an axial gap that extends circumferentially between the rotating parts and the stationary parts of the turbine;
the rotor blade includes an airfoil that resides in a working fluid flowpath through the turbine and interacts with a working fluid flowing therethrough;
the turbine stator blade includes an airfoil that resides in the working fluid flowpath through the turbine and interacts with the working fluid flowing therethrough;
the trench cavity comprises one formed between an upstream side of the rotor blade and a downstream side of the stator blade; and
the seal comprises an axial profile between a row of rotor blades samely configured as the rotor blade and a row of stator blades samely configured as the stator blade.

19. The gas turbine according to claim 2, wherein:
the trench cavity comprises an axial gap that extends circumferentially between the rotating parts and the stationary parts of the turbine;
the rotor blade includes an airfoil that resides in a working fluid flowpath through the turbine and interacts with a working fluid flowing therethrough;
the turbine stator blade includes an airfoil that resides in the working fluid flowpath through the turbine and interacts with the working fluid flowing therethrough;
the trench cavity comprises one formed between a downstream side of the rotor blade and an upstream side of the stator blade; and
the seal comprises an axial profile between a row of rotor blades samely configured as the rotor blade and a row of stator blades samely configured as the stator blade.

20. A gas turbine engine comprising a turbine including a stator blade and a rotor blade having a seal formed in a trench cavity formed therebetween, the trench cavity comprising an axial gap defined between a stator inboard face and a rotor inboard face, the seal comprising:
a stator overhang formed on the stator blade face that extends axially toward the rotor inboard face, the stator overhang comprising an overhang topside, which defines an inner boundary of a working fluid flowpath through the turbine, an overhang underside, which opposes the overhang topside, and an overhang face, which is defined between the overhang topside and underside;
a platform having a platform lip extending axially from the rotor inboard face toward the stator inboard face; and
circumferentially spaced turbulators extending axially from the rotor inboard face, the turbulators being positioned inboard of the platform lip;
wherein an outboard edge and an inboard edge of the stator overhang each comprises an axially jutting edge such that, therebetween, a recessed pocket on the overhang face is formed;
wherein the platform lip radially overlaps the recessed pocket on the overhang face of the stator overhang and is positioned relative thereto so to form a first multiple switch-back flowpath in a mouth section of the trench cavity formed therebetween;
wherein the stator overhang further comprises inner and outer protuberances that jut radially inboard and, between the inner and outer protuberances, an underside recessed pocket;
wherein the axial projection comprises a tip that is overhung by the stator overhang so that the tip of the axial projection axially aligns with the underside recessed pocket, the tip of the axial projection comprising an upturned tip that extends toward an outboard direction such that a second multiple switch-back flowpath is formed between the tip of the axial projection and the underside recessed pocket; and
wherein each of the turbulators comprises: a rib-like member extending radially inward; and a concave face opening toward an intended direction of rotation of the rotor blade.
